(19) United States
(12) Patent Application Publication
(10) Pub. No.: US 2013/0316312 A1
(43) Pub. Date: Nov. 28, 2013

(54) Apparatus for Displaying Braille on an Attachable Device and Method Thereof

(71) Applicant: Joy Qiu Jin, Palo Alto, CA (US)

(72) Inventor: Joy Qiu Jin, Palo Alto, CA (US)

(21) Appl. No.: 13/478,021

(22) Filed: May 22, 2012

(51) Int. Cl. G09B 21/02

(52) U.S. Cl. 434/114

(57) ABSTRACT

The present invention includes a flat face, a dots raising mechanism, a display cell, a first column, a second column, an interface, and a connection port. The first column includes a first dot, second dot, and a third dot while the second column includes a fourth dot, a fifth dot, and a sixth dot. The columns are on the display cell. The display cell is capable of displaying a single Braille character. To convey information from a text source, the display cell raises and lowers the dots, successively forming different characters. A first time interval, a second time interval, and a third time interval help differentiate the first column from the second column, a first character from a following character, and a first word from a following word. The time intervals simulate physical space between and with the cells found in printed Braille.

### FIELD OF THE INVENTION

The present invention relates generally to a method for displaying Braille text utilizing a single display cell.

### BACKGROUND OF THE INVENTION

As technology progresses and may consumer electronics are updated, persons with visual impairment are often left behind. The advancement of technology presents an increasingly insurmountable communication gap. Operating electronic devices often proves difficult for those with visual impairments, increasing the difficulty of sending email, text messages, making phone calls, and similar actions. Some attempts have been made to increase the usability of consumer electronics, offering improved devices, programs, or both. There have been advancements which allow Braille text to be created on electronic devices, increasing the usability of said devices. However, these devices tend to be somewhat large and complicated. It is therefore an object of the present invention to introduce an apparatus and method for displaying Braille characters using a single display cell. By using a single Braille cell the present invention reduces the complexity, size, and required materials when compared to existing devices.

### BRIEF DESCRIPTION OF THE DRAWINGS

FIG. 1 is a chart showing the characters of grade 1 Braille.

FIG. 2 is a chart showing some abbreviations used in grade 2 Braille.

FIG. 3 is a front perspective view showing the present invention integrated into a PDA.

FIG. 4 is a side view thereof.

FIG. 5 is a front perspective view showing the present invention as an accessory.

FIG. 6 is a front view showing the present invention integrated into an elevator button.

FIG. 7 is a flow chart illustrating the process of displaying characters, words, and sentences.

FIG. 8 is a graph illustrating how columns, characters, and words are separated by time intervals.

FIG. 9 is a flowchart illustrating the application of a first time interval.

FIG. 10 is a flowchart illustrating the application of a second time interval.

FIG. 11 is a flowchart illustrating the application of a third time interval.

### DETAIL DESCRIPTIONS OF THE INVENTION

All illustrations of the drawings are for the purpose of describing selected versions of the present invention and are not intended to limit the scope of the present invention.

An electronic attachable panel for displaying Braille comprises a flat face 1, a dots raising mechanism 2, a display cell 3, an interface 4, and a connection port 5. The display cell 3 is positioned on the flat face 1, while the dots raising mechanism 2 is placed beneath the display cell 3. The dots raising mechanism 2 controls the creation of dots on the display cell 3, forming different characters in Braille by raising at least one of the dots on the display cell 3.

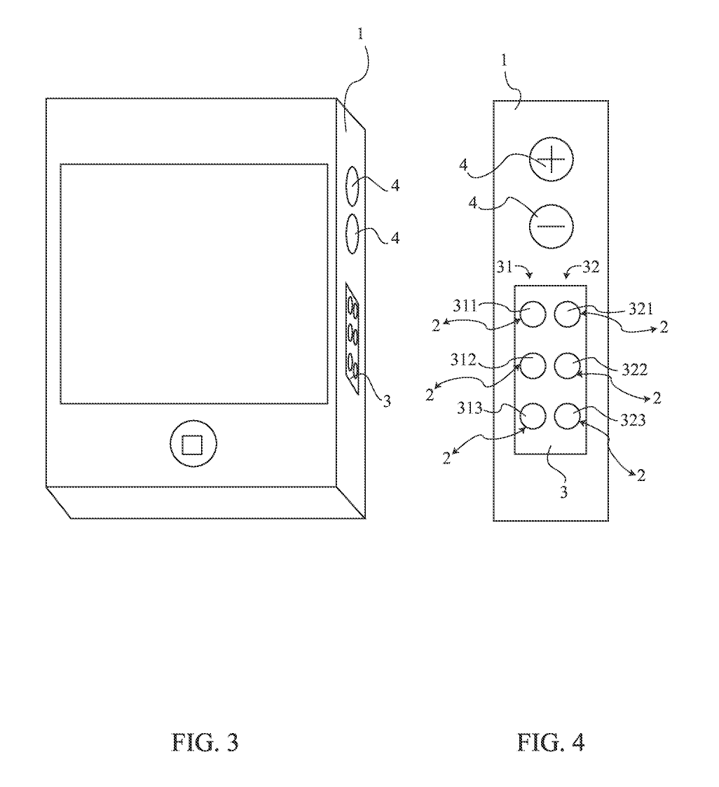

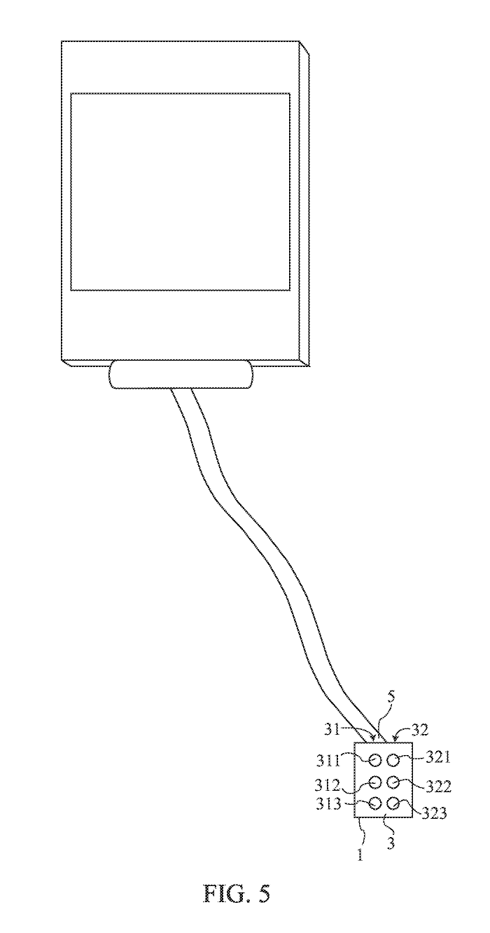

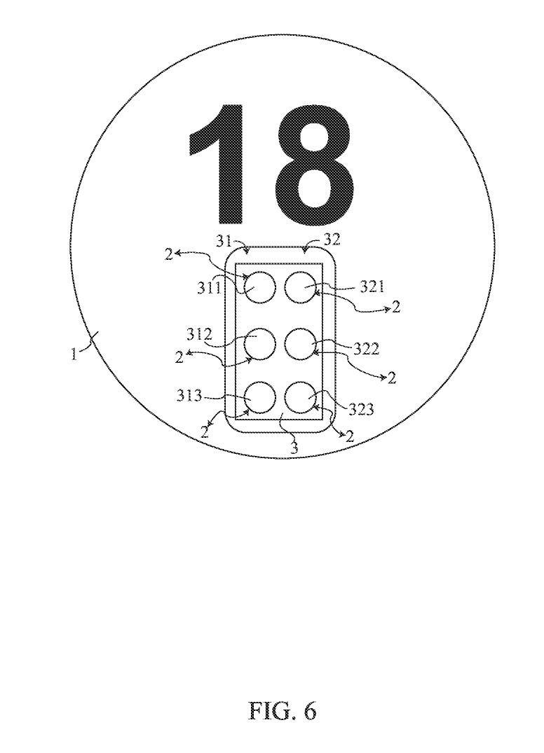

The display cell 3 comprises a first column 31 and a second column 32, as seen in FIG. 3, FIG. 4, FIG. 5, and FIG. 6. The first column 31 each comprise three dots; the first column 31 comprises a first dot 311, a second dot 312, and a third dot 313, while the second column 32 comprises a fourth dot 321, fifth dot 322, and sixth dot 323. The dots are aligned with each other to form rows, such that the first dot 311 and fourth dot 321 form a first row, the second dot 312 and fifth dot 322 form a second row, and the third dot 313 and sixth dot 323 form a third row. In effect, the display cell 3 is a matrix with two columns and three rows. The display cell 3 can be used to display Braille characters, also known as cells. Braille uses different arranges of bumps, or “dots”, in a three-by-two matrix (cell) to form different characters and punctuation marks.

In other embodiments, and additional row can be added to the display cell 3, such that there are a total of 8 dots. This 8 dot Braille allows for more combinations than 6 dot Braille. While other embodiments may utilize 8 dot Braille, the present invention will function the same for 6 dot Braille and 8 dot Braille.

A dots raising mechanism 2 is located under the display cell 3 and connects to the dots of the first column 31 and the second column 32. The dots raising mechanism 2 is used to raise certain dots on the display cell 3 to form a character. For example, the second dot 312 and the fourth dot 321 could be raised to form the character “i”. The dots raising mechanism 2 can be implemented in various ways. The dots raising mechanism 2 could be a basic assembly that uses pins and levers to mechanically lift the dots of the display cell 3. Alternatively, the dots raising mechanism 2 could apply voltage to an electric active plastic, changing the structure of the electric active plastic to create raised dots on the display cell 3. Other methods of creating raised dots can be used, although the ideal method will be able to refresh quickly. In other words, the dots raining mechanism 2 should be capable of quickly raising dots, such that there is not a large delay between displaying a first character and a following character.

The interface 4 allows a user to adjust certain aspects of the invention. While the interface 4 could be digital or physical, preferably it would be physical to provide tactile feedback, an advantage when the average user will be visually impaired. Examples of a physical interface 4 include buttons, knobs, and switches. Different implementations could be combined to simplify the user interface 4. For example, a knob and button could be combined into a single button-knob. Rotating the knob part would adjust intensity (such as how fast or slow a time interval is) while pushing the button would change which time interval is being adjusted.

The connection port 5 allows the present invention to communicate with other devices. The connection port 5 take different forms, being wired, wireless, or integrated. For example, the connection port 5 could be a simple USB port allowing the present invention to plug into a device with a free USB port. Alternatively, the connection port 5 could be a wireless chip, such as Bluetooth, allowing the present invention to sync with other Bluetooth devices. The present invention can even be integrated into devices, with the connection port 5 internally connected to a device. For example, as shown in FIG. 3 and FIG. 4, in a smart phone the present invention can be integrated on a lateral side of the smart phone. On thinner devices, such as mp3 players and some PDA's, the present invention can use the wired or wireless connection to connect to a device, like illustrated in FIG. 5.

The present invention can be used in numerous different situations, either integrated into a device or attached to a device. If the device is thick enough, such as a smart phone, the present invention may be built into a lateral side of the smart phone. This will enable a visually impaired user to read the Braille output by the display cell 3 while holding the smart phone. For thinner devices, where a lateral side may be too small to fit the present invention, the present invention may be connected by a USB cord. This enables smaller devices, without sufficient space for a dedicated Braille display, to be made accessible to the visually impaired.

The present invention can be used for various applications when connected to different devices. For example, the present invention could be built into elevator buttons, such as in FIG. 6. The present invention could then display information about different floors. For example, in a hospital the present invention could relay descriptions of specific wards and rooms located on different floors of the hospital. In another embodiment, the present invention could sync with a countdown timer at a crosswalk, communicating through the Braille display the amount of time left before a light change. The present invention can be utilized in a wide variety of other situations due to its small size and lower cost, especially when compared to traditional Braille displays.

The method for displaying Braille requires an data source, an interface 4, and a display cell 3. The display cell 3 has a plurality of dots arranged in a first column 31 and a second column 32. Text is received from the data source to be displayed on the display cell 3.

The process starts when source text is received from the data source. When the source text is received, it is translated into Braille text. The translated Braille text is stored as individual characters, retaining the same order of characters as received from the source text. After the source text has been translated into Braille text, the Braille text is displayed on the display cell 3. As there is only a single display cell 3, only one character of Braille text is displayed at any given time. Words and sentences are formed by displaying successive characters from the Braille text.

To display an individual character, the dots in the first column 31 and the second column 32 are raised, forming a character. For example, to display the character for “h”, the first dot 311 and the second dot 312 in the first column 31 and the fifth dot 322 in the second column 32 would be activated. Thus, the display cell 3 would have three raised dots (the first dot 311, second dot 312, and fifth dot 322) and three inactive dots (the third dot 313, fourth dot 321, and sixth dot 323). In addition, to simulate the movement of a finger over printed Braille, there would be a pause between raising the dots in the first column 31 and the dots in the second column 32.

To display a word, the characters forming the word must be displayed in succession. After the first character is displayed, the dots in the first column 31 and the second column 32 are lowered. Thus, between displaying the first character and a following character, the display cell 3 returns to a blank slate with all of the dots being inactive. Once the display cell 3 has been returned to a blank slate, the dots need to form the following character are raised. Continuing the previous example, if the following character is “i”, the following character is displayed by raising the second dot 312 in the first column 31 and the fourth dot 321 in the second column 32. Thus, the display cell 3 would have two raised dots (the second dot 312 and the fourth dot 321) and four inactive dots (the first dot 311, third dot 313, fifth dot 322, and sixth dot 323).

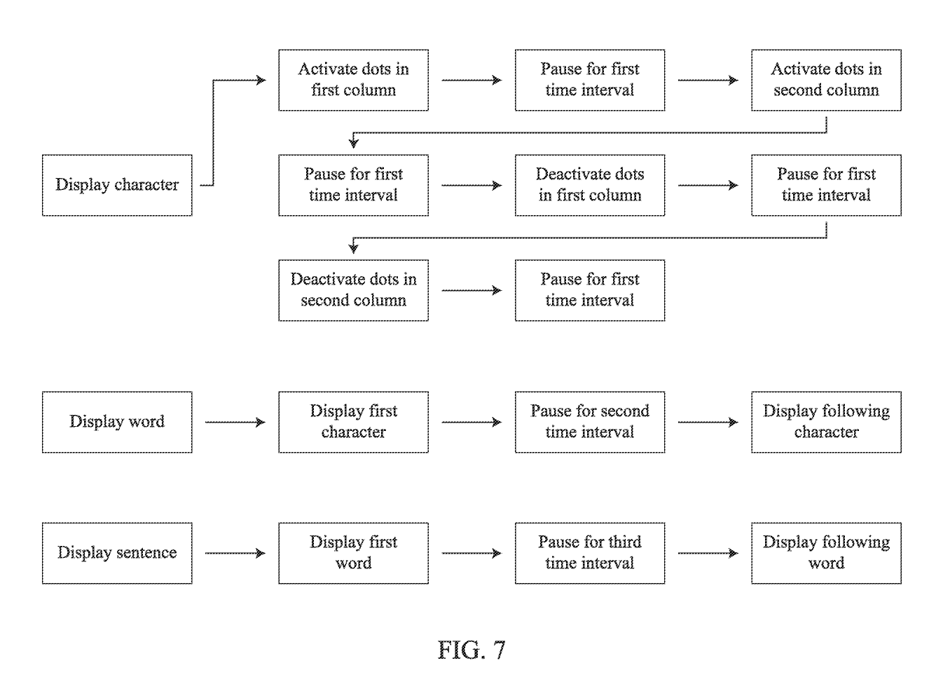

By repeating this process words can be relayed through the display panel by successively displaying individual characters. Sentences are conveyed in a similar manner; individual characters are displayed to form words, which themselves form sentences. The formation of each unit (columns, characters, words, and sentences) is shown in FIG. 7. Thus the same basic process (raising dots to form characters and lowering dots to delineate the transition between different characters) can be used to convey information for the visually impaired using only a single display cell 3.

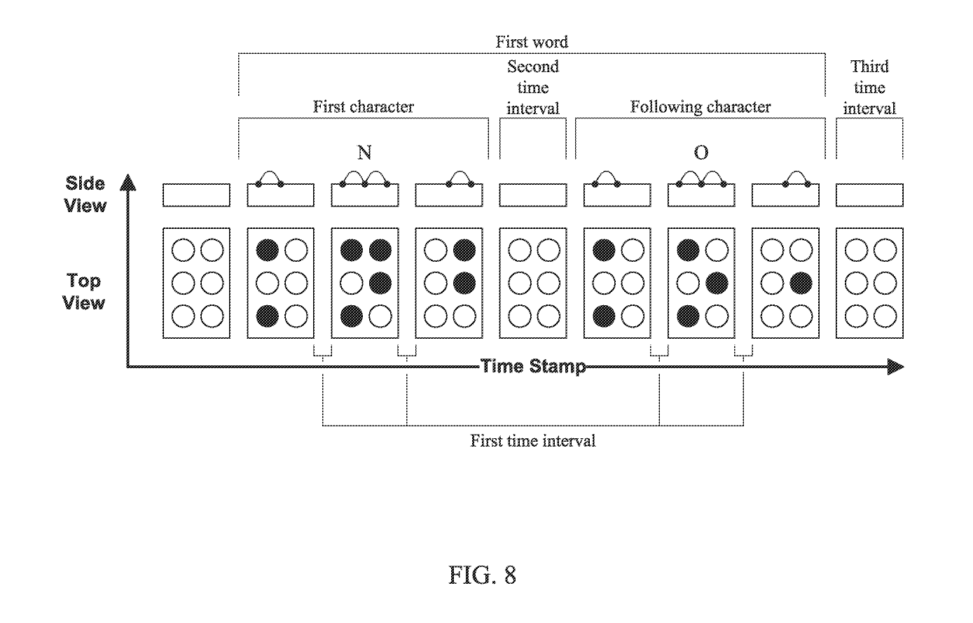

To simulate the application of space (movement of fingers) when reading printed Braille, time intervals are used between activating the dots on the display cell 3. This gives the sensation that a user's finger is moving over the dots of printed Braille. Three separate time intervals are used to simulate reading printed Braille. Each time interval simulate a space between columns, characters, or words in printed Braille. A first time interval represents the space between the two columns of a printed Braille character. A second time interval represents the space between two adjacent characters of printed Braille. A third time interval represents the space between two adjacent words in printed Braille. The relation between these time intervals and the display of columns, characters, and words is visually represented in FIG. 8.

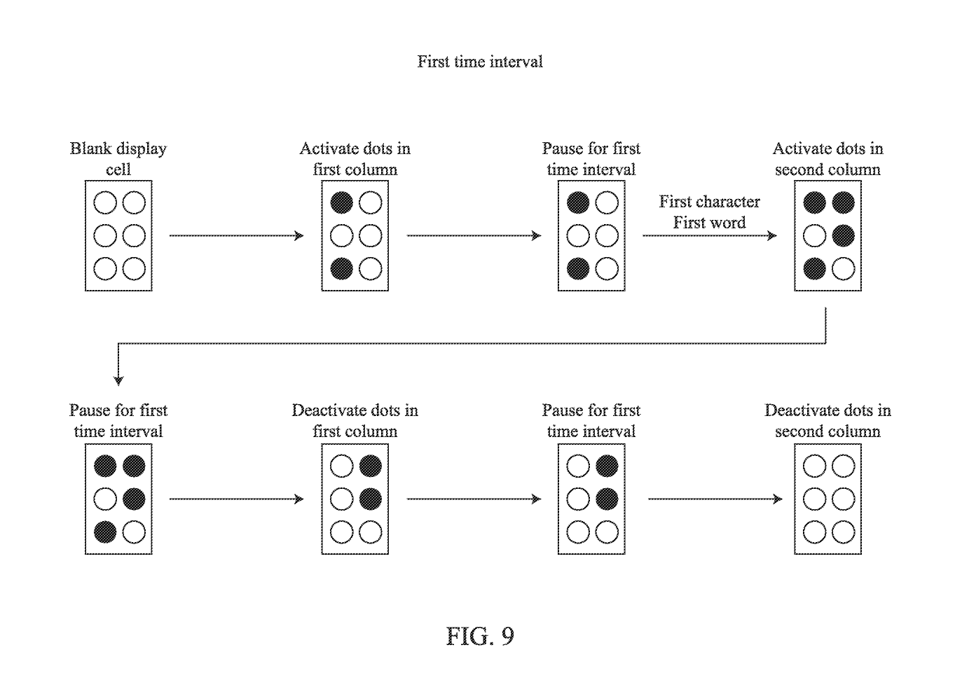

The first time interval, illustrated in FIG. 9, occurs when displaying an individual character of Braille. After raising the dots in the first column 31, the display cell 3 remains static for the first time interval. After waiting for the first time interval, the dots in the second column 32 are raised. A user whose finger is on the display cell 3 will thus feel the dots in the first column 31 before feeling the dots in the second column 32. This is tactilely equivalent to moving a finger over printed Braille. The display cell 3 repeats the first time interval when lowering the dots; the dots in the first column 31 are lowered, the display cell 3 remains static for the first time interval, then the dots in the second column 32 are lowered. In combination, the above represents the sensations when reading a single character of printed Braille.

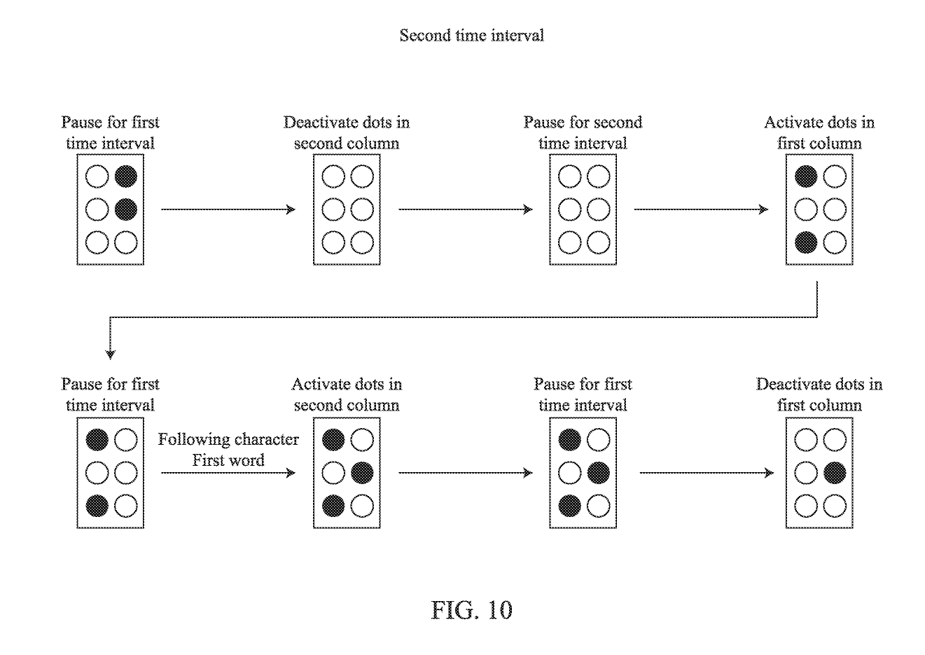

The second time interval, illustrated in FIG. 10, occurs between displaying a first character and a following character. In printed Braille, the second time interval is equivalent to the space between characters. After displaying a first character, but before displaying a following character, the display cell 3 remains static for the second time interval. The second time interval begins immediately after the dots in the second column 32 of a first character have been lowered. After the second time interval elapses, the dots in the first column 31 of a following character are raised. The above represents the space between individual characters when reading a word in printed Braille.

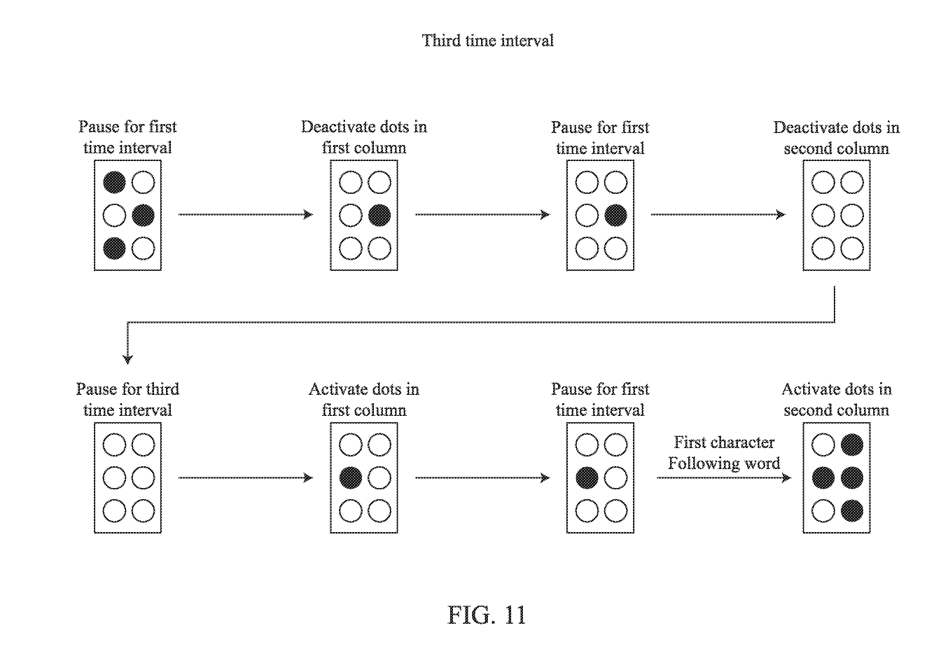

The third time interval, illustrated in FIG. 11, occurs between displaying a first word and a following word. In printed Braille, the third time interval is equivalent to the space between words. After displaying the last character of a first word, but before displaying the first character of a following word, the display cell 3 remains static for the third time interval. The third time interval begins immediately after the dots in the second column 32 of a last character of a first word have been lowered. After the third time interval elapses, the dots in the first column 31 of a first character in a following word are raised. The above represents the space between words when reading sentences in printed Braille.

As the first time interval, second time interval, and third time interval relate to physical gaps in printed Braille, they should have corresponding difference in duration. That is, the gap between two columns of a display cell 3 is smaller than the gap between two characters, which itself is smaller than the gap between two words. Thus, the first time interval should be shorter than the second time interval, which should be shorter than the third time interval.

The interface 4 allows a user to adjust the time intervals, the direction in which text is displayed, and the level of Braille that is displayed. Since different users will be comfortable with different reading speeds, the interface 4 allows a user to increase or decrease each of the intervals. If someone finds the default settings too fast, they can use the interface 4 to increase the time intervals. Alternatively, if someone finds the default setting too slow, they can use the interface 4 to decrease the time intervals. Shorter time intervals are equivalent to someone who moves their finger across printed Braille at a very fast speed. Longer time intervals are equivalent to someone who moves their finger across printed Braille at a slow speed. Thus the interface 4 allows users to adjust the time intervals to meet the users' reading preferences.

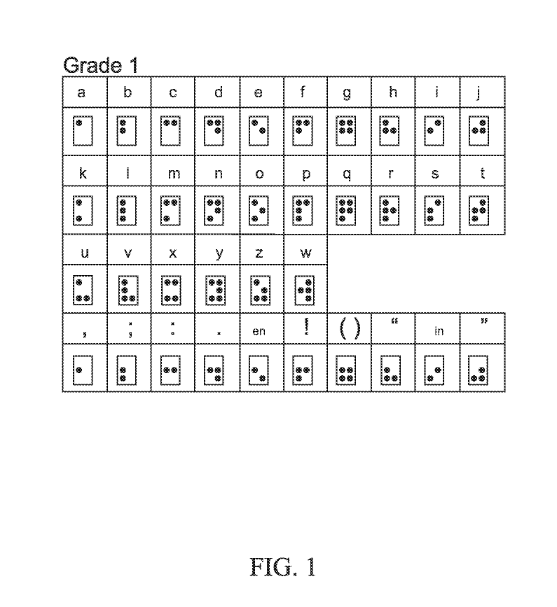

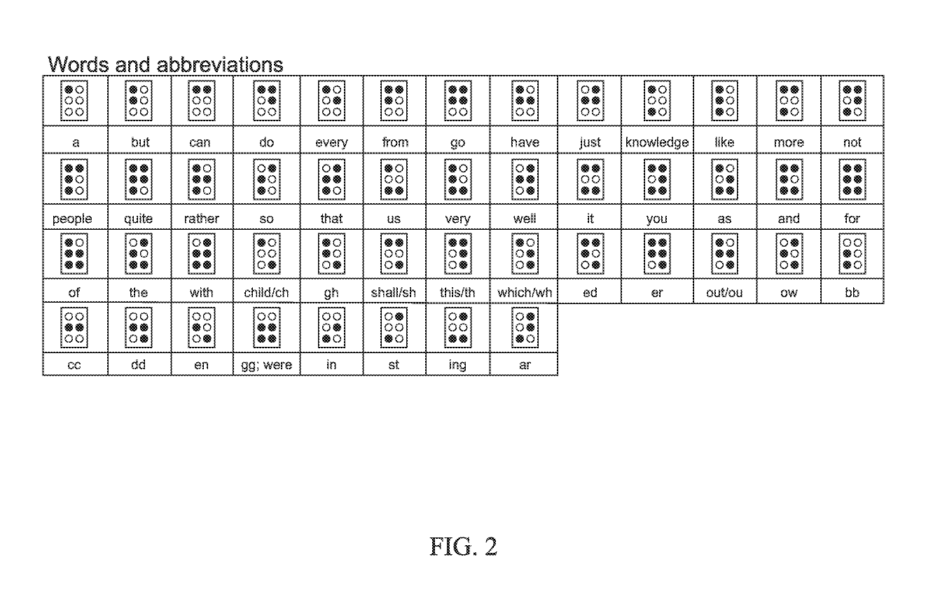

As the speed at which users are able to read Braille may vary, so may user's fluency in Braille. For example, someone who has only recently learned Braille may only be familiar with grade 1 Braille, as seen in FIG. 1, which only covers the basic 26 characters and some additional punctuation. However, someone who has been reading Braille for a long time may be comfortable with grade 2 Braille, as seen in FIG. 2, which introduces contractions and abbreviations. The interface 4 allows a user to adjust the level of translated Braille. A user who is not experienced in Braille could select a simpler level of translated Braille, such as grade 1, while a user who is fluent in Braille could select a more complicated but efficient translation, such as grade 2.

Lastly, the interface 4 would allow a user to adjust the direction in which the Braille is displayed. In some cultures text is read right-to-left rather than left-to-right. To accommodate for this, the interface 4 could be used to switch the direction of text. The preferred embodiment has discussed displaying text for someone who reads left-to-right. If a user selects to display text from right-to-left, the process in which individual characters are displayed would slightly change. Instead of displaying a character by raising dots in the first column 31 followed by raising dots in the second column 32, dots in the second column 32 would be raised followed by raising dots in the first column 31. A user's finger would encounter the dots in the second column 32 before the dots in the first column 31, equivalent to reading printed Braille from right-to-left.

Although the invention has been explained in relation to its preferred embodiment, it is to be understood that many other possible modifications and variations can be made without departing from the spirit and scope of the invention as hereinafter claimed.

What is claimed is:

1. A method for displaying Braille by executing computer-executable instructions stored on a non-transitory computer-readable medium, the method comprises the steps of:
providing an data source, an interface, and a display cell with a plurality of dots, wherein the display cell comprises the plurality of dots grouped into a first column and a second column;
receiving source text from the data source;
translating the source text into Braille text, wherein the Braille text comprises a plurality of characters;
displaying the Braille text on the display cell by activating at least one of the plurality of raised dots, wherein the plurality of raised dots form one of the plurality of characters from the Braille text;
activating raised dots in the first column followed by activating raised dots in the second column;
displaying the Braille text by successively displaying individual characters from the plurality of characters, wherein the plurality of characters form words and the plurality of words form sentences;
successively displaying at least one of the plurality of characters to form a word;
successively displaying at least one of the plurality of words to form a sentence;
waiting a first time interval between activating raised dots in the first column and activating raised dots in the second column to simulate printed Braille, wherein the first time interval represents a space between two columns of a cell in printed Braille;
deactivating raised dots in the first column and deactivating raised dots in the second column between displaying a first character and displaying a following character;
waiting the first time interval between deactivating raised dots in the first column and deactivating raised dots in the second column;
waiting a second time interval between displaying the first character and the following character to simulate printed Braille, wherein the second time interval represents the space between two adjacent cells in printed Braille; and
waiting a third time interval between displaying the characters from a first word and the characters from a following word, wherein the third time interval represents the space between two adjacent words in printed Braille.

2. The method for displaying Braille by executing computer-executable instructions stored on a non-transitory computer-readable medium, the method as claimed in claim 1 comprises the step of:
using the interface to adjust the translated Braille text, wherein the Braille text may be grade 1 Braille or grade 2 Braille.

3. The method for displaying Braille by executing computer-executable instructions stored on a non-transitory computer-readable medium, the method as claimed in claim 2 comprises the step of:
translating the source text into grade 1 Braille, wherein grade 1 Braille uses a small and basic set of characters.

4. The method for displaying Braille by executing computer-executable instructions stored on a non-transitory computer-readable medium, the method as claimed in claim 2 comprises the step of:
translating the source text into grade 2 Braille, wherein grade 2 Braille uses a large and advanced set of characters.

5. The method for displaying Braille by executing computer-executable instructions stored on a non-transitory computer-readable medium, the method as claimed in claim 1 comprises the steps of:
storing the order of characters received from the source text; and
displaying the plurality of characters from the Braille text in the same order the characters appear in the source text.

6. The method for displaying Braille by executing computer-executable instructions stored on a non-transitory computer-readable medium, the method as claimed in claim 1 comprises the step of:
receiving a directional text instruction from the interface to adjust displaying the Braille text.

7. The method for displaying Braille by executing computer-executable instructions stored on a non-transitory computer-readable medium, the method as claimed in claim 6 comprises the step of:
activating raised dots in the first column before creating raised dots in the second column to represent reading left-to-right.

8. The method for displaying Braille by executing computer-executable instructions stored on a non-transitory computer-readable medium, the method as claimed in claim 6 comprises the step of:
activating raised dots in the second column before creating raised dots in the first column to represent reading right-to-left.

9. The method for displaying Braille by executing computer-executable instructions stored on a non-transitory computer-readable medium, the method as claimed in claim 1 comprises the steps of:
receiving and instruction from the interface to adjust the first time interval;
receiving and instruction from the interface to adjust the second time interval; and
receiving and instruction from the interface to adjust the third time interval.

10. The method for displaying Braille by executing computer-executable instructions stored on a non-transitory computer-readable medium, the method as claimed in claim 9, wherein the first time interval is shorter than the second time interval, and the second time interval is shorter than the third time interval.

11. An attachable panel for displaying Braille comprises,
a flat face;
a dots raising mechanism;
a display cell comprises a first column and a second column;
the first column comprises a first dot, a second dot, and a third dot;
the second column comprises a fourth dot, a fifth dot, and a sixth dot;
an interface;
a connection port;
the dots raising mechanism being positioned underneath the display cell;
the first column being adjacent to the second column;
the first dot, the second dot, the third dot, the fourth dot, the fifth dot, and the sixth dot each being bistably connected to the display cell;
the dots raising mechanism being connected to the first dot, the second dot, the third dot, the fourth dot, the fifth dot, and the sixth dot;
the display cell being positioned on the flat face; and
the interface being positioned on the flat face and outside of the display cell.

12. The attachable panel for displaying Braille as claimed in claim 11, wherein the flat face is positioned on the side of an electronic device.

13. The attachable panel for displaying Braille as claimed in claim 11 comprises,
the first dot, the second dot, the third dot, the fourth dot, the fifth dot, and the sixth dot each being movable.
